(19) United States
(12) Patent Application Publication
(10) Pub. No.: US 2013/0234930 A1
(43) Pub. Date: Sep. 12, 2013

(54) SCANNING MIRROR LASER AND PROJECTOR HEAD-UP DISPLAY GLASSES

(71) Applicant: Julian Palacios Goerger, Madrid (ES)

(72) Inventor: Julian Palacios Goerger, Madrid (ES)

(21) Appl. No.: 13/765,466

(22) Filed: Feb. 12, 2013

Related U.S. Application Data
(60) Provisional application No. 61/607,626, filed on Mar. 7, 2012.

(51) Int. Cl. G02B 27/01; G06F 3/01

(52) U.S. Cl. CPC G02B 27/017; G06F 3/013
USPC 345/156; 345/8

(57) ABSTRACT

This application consists of a method for wearable heads-up display devices to display image or video that does not require the user to focus his eyes on the display of the device.

### RELATED APPLICATION

This non-provisional utility patent application claims the benefit of the filing date of the provisional patent application with application Ser. No. 61/607,626 with filing date of Mar. 7, 2012. This non-provisional utility patent application bears the same title as the prior provisional patent application.

### FIELD

This application pertains to the field of optics and wearable devices.

### BACKGROUND OF THE INVENTION

Current image or video display systems face a challenge when placed close to the eye of a person because the eye cannot focus on the display if the display is placed too close to the eye.

### BRIEF SUMMARY OF THE INVENTION

The system described herein overcomes the issue of a display placed too close to the eye by directing the rays of light directly towards the eye in the form of beams, each beam corresponding to a pixel of the image.

### BRIEF DESCRIPTION OF THE DRAWINGS

FIG. 1: An example of two beams that are directed towards an eye ball and are naturally focused at two points on the retina by the lens of the eye.

FIG. 2: An extension of FIG. 1 that includes the reflective surface of the glasses and a mirror. This figure shows how all the beams incident on the eye emerge from the mirror and are reflected on the surface of the glasses.

FIG. 3: An extension of FIG. 1 that includes transparent light emitting elements positioned on the surface of the glasses. Only the beams from two elements are shown.

FIG. 4: A pair of glasses that hold a laser or projector and mirrors. Again, only two beams are shown for simplicity.

### DETAILED DESCRIPTION OF THE INVENTION

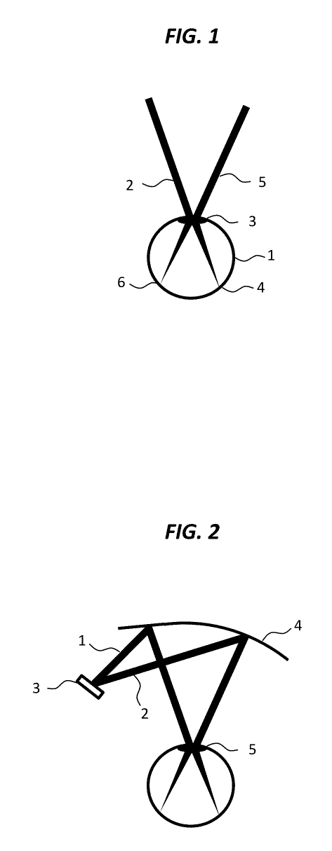

The solution to the problem of having a screen so close to the eye that the eye cannot focus on it is to convert each pixel of the image into a parallel beam of light, each of which has to be directed towards the center of the lens of the eye. This allows the eyes to remain relaxed or focused at a long-distance while still seeing the image or video that is being displayed. Each parallel beam of light is naturally focused by the relaxed lens of the eye to a single point on the retina of the eye. The position of this point on the retina will only depend on the angle of incidence of the beam. Changing the angle of incidence of the beam results in the beam being focused by the lens of the eye onto a different point of the retina. To illustrate this FIG. 1 shows an eye ball 1 and a beam of parallel rays of light (termed a “beam” from now on) 2 that is aimed at the center of the lens of the eye 3, and is focused by the lens of the eye to a single point on the retina 4. A different beam that is aimed at the lens of the eye with a different angle to the previous one 5 is focused by the lens of the eye to a different point on the retina 6. Thus by using a large number of beams, an image can be created at the retina with each beam corresponding to a pixel of the image. Alternatively instead of using multiple beams, one can quickly scan a single beam across the retina and also obtain an image.

In order to quickly scan a beam, one or two oscillating mirrors are required to create a two dimensional image. One mirror is required if the mirror can oscillate in two directions and two mirrors are required if each mirror oscillates in one direction. FIG. 2 shows how two example beams, 1 and 2, originate from a mirror 3 and are reflect on the surface of the glasses 4 and are thus directed towards the lens of the eye 5. Beams 1 and 2 can represent two different time points in the case of a single scanning beam. Beams 1 and 2 can also represent a single time point if instead of using a single beam, multiple beams are used at the same time that come from a projector that originally projected the beams onto the mirror.

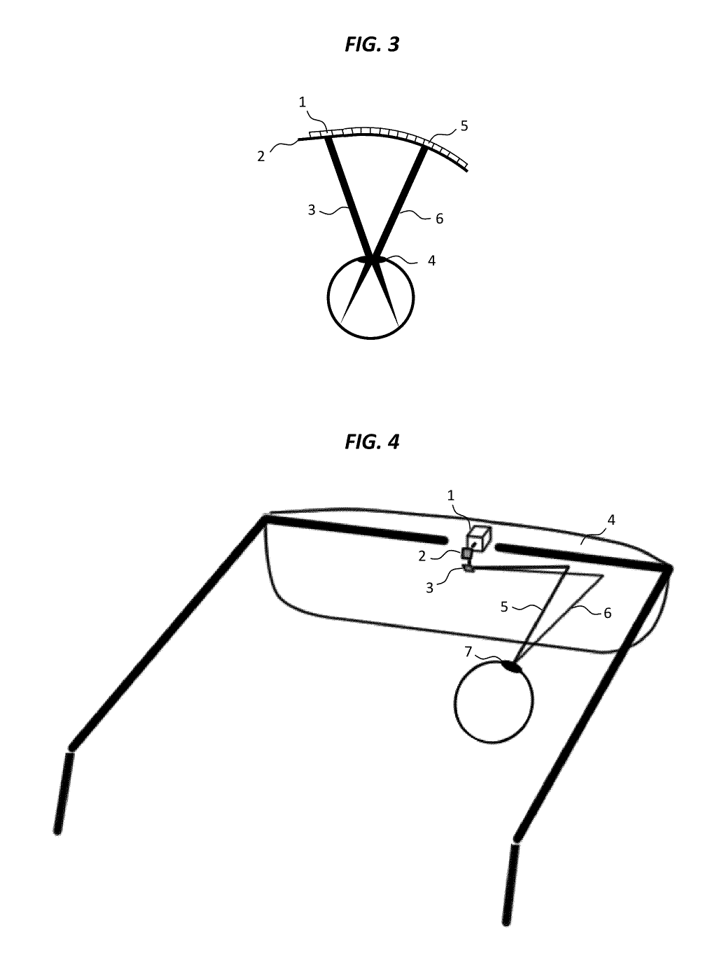

An alternative approach consists of having the glasses emit the light themselves. In this approach the glasses contain a large number of transparent light emitting elements such as laser diodes. As illustrated in FIG. 3 the elements emit light in parallel beams toward the eye. Element 1 situated on the surface of the glasses 2 produces beam 3 aimed at the lens of the eye 4. Element 5 produces beam 6. Each light emitting element corresponds to a pixel. In this approach no mirrors are required and an image will be created when all the elements are illuminating.

To summarize, there are three approaches. One approach is to rapidly and continuously vary the angle of incidence of a single beam. In other words, the beam will be scanned on the retina and the person will see an image. A second approach consists of replacing the laser with a projector. Commercially available projectors can produce images on a screen and the focus of such projectors can easily be changed by adjusting the main lens of the projector. One can thus project an image with parallel rays of light that will be reflected by the surface of the glasses towards the center of the eye, obtaining the same result as with the first approach. An example of an apparatus to embody either of these two approaches consists of a pair of glasses that hold a laser or a projector and two scanning mirrors as illustrated in FIG. 4. A laser or projector 1 produces a single beam or multiple beams that are reflected on a mirror 2 (and then, optionally, on a second mirror 3) which direct the beams toward the reflective surface of the glasses 4. The curvature of the glasses is such that the beams will always be directed towards the eye and so beams 5 and 6 will enter the eye through the lens of the eye 7.

As in conventional display systems, the intensity and color of the laser or projector must be modulated in time by a computer and synchronized with the scanning to produce the desired images. The novelty of the proposed system is that the wearer of the glasses does not have to consciously focus his eyes to view the display, instead the image will be viewed when the eye is relaxed and the person is looking at the horizon or at some comfortable distance.

The system described thus far permits the wearer of the glasses to see an image in one or both of his eyes. If both eyes are employed, this system can produce three dimensional images. Three dimensional images are obtained by slightly offsetting the image received by one eye with respect to the other eye as used in commercially available 3D systems.

For the system described herein to function properly it is essential that the beams of light are directed towards the center of the lens of the eye. This mean that if the eyes move then the person will no longer see an image. This is so because if the eyes move, the beams of light will no longer fall on the center of the lens of the eye. This can be advantageous if the person only wants to see an image when looking in a certain direction. However there is a mechanism that can make it possible for the wearer of the glasses to see an image irrespective of where he is looking and irrespective of the position of his eyes. This is achieved by using a camera or a motion detection device that records the position of the eyes and adjusts the mirrors accordingly in order to always direct the beams of light towards the center of the lens of the eye.

1. I claim a method for wearable display devices that displays images or video to the person who wears the device wherein the improvement comprises that the person wearing the device does not have to focus their eyes on the display, instead the eyes can remain relaxed and focused at an arbitraty distance, and this is achieved by directing beams of light toward the eye from various angles.

2. The method of claim 1, wherein a laser beam is scanned and reflected off a surface placed in front of the eye.

3. The method of claim 1, wherein a projector produces the image that is reflected off a surface placed in front of the eye.

4. The method of claim 1, wherein transparent light emitting elements such as laser diodes emit the light into the eye without the need for a reflecting surface.

5. The method of claim 1, wherein the angles of the beams are automatically corrected to match the position of the eyes by using a camera or motion detection device that tracks the position of the eyes.
